(19) United States
(12) Patent Application Publication
(10) Pub. No.: US 2011/0167358 A1
(43) Pub. Date: Jul. 7, 2011

(54) ONLINE COOPERATIVE STORY BUILDING METHOD AND SYSTEM

(76) Inventors: Christian ROBILLARD, Montreal (CA); Conception Lévy, Monttreal (CA)

(21) Appl. No.: 12/985,226

(22) Filed: Jan. 5, 2011

Related U.S. Application Data
(60) Provisional application No. 61/292,199, filed on Jan. 5, 2010.

(51) Int. Cl. G06F 3/01

(52) U.S. Cl. 715/753

(57) ABSTRACT

A computer implemented method for allowing users to cooperate in iteratively building a story, the method comprising setting a seed material for the story, starting a material submission period, prompting the users to submit materials, uploading the submitted materials, ending the material submission period, starting a voting period for the submitted materials, registering votes from the users for each of the submitted materials, ending the voting period, identifying one of the submitted materials having the highest number of registered votes and updating the story with the identified submitted material.

### CROSS-REFERENCE TO RELATED APPLICATION

This application claims the benefits of U.S. provisional patent applications No. 61/292,199 filed Jan. 5, 2010; which is hereby incorporated by reference.

### TECHNICAL FIELD

The present invention relates to an online cooperative story building method and system.

### BACKGROUND

Numerous social network websites exist which allow members to communicate with other members as well as statically share information, stories, photos and videos. However, a need exists for websites which allow members to cooperate in iteratively building dynamic story lines.

### SUMMARY

The present invention relates to an online cooperative story building method and system in which members (users) cooperate in iteratively building story lines in the form of thread by submitting text, pictures, drawings, videos, music or any combination thereof, and voting for their preferred submissions.

More specifically, in accordance with the present invention, there is provided a computer implemented method for allowing users to cooperate in iteratively building a story, the method comprising:
a. setting a seed material for the story;
b. starting a material submission period;
c. prompting the users to submit materials;
d. uploading the submitted materials;
e, ending the material submission period;
f. starting a voting period for the submitted materials;
g. registering votes from the users for each of the submitted materials;
h. ending the voting period;
i. identifying one of the submitted materials having the highest number of registered votes; and
j. updating the story with the identified submitted material.

In accordance with the present invention, there is also provided a system for allowing users to cooperate in iteratively building a story, the system comprising:
a material database;
an input;
an output;
a processor operatively connected to the database, the input and the output, wherein the processor is so configured so as to;
   a. set a seed material for the story;
   b. start a material submission period;
   c. prompt the users to submit materials through the output;
   d. upload the submitted materials to the material database through the input;
   e. end the material submission period;
   f. start a voting period for the submitted materials through the output;
   g. register votes from the users for each of the sub fitted materials through the input;
   h. end the voting period;
   i. identify one of the submitted materials in the material database having the highest number of registered votes; and
   j. update the story with the identified submitted material.

### BRIEF DESCRIPTION OF THE FIGURES

Embodiments of the invention will be described by way of example only with reference to the accompanying drawings, in which:

FIG. 1 is a schematic view of computing devices connected to a an online cooperative story building system through a network;

FIG. 2 is a flow diagram depicting the process of accessing the online cooperative story building system;

FIG. 3 is a flow diagram depicting the guest access process according to an illustrative embodiment of the present invention;

FIG. 4 is a flow diagram depicting the contributor access process according to an illustrative embodiment of the present invention;

FIG. 5 is a flow diagram depicting the editor access process according to an illustrative embodiment of the present invention;

FIG. 6 is a flow diagram depicting the thread update process according to an illustrative embodiment of the present invention;

FIG. 7 is a flow diagram depicting the batting thread update process according to an alternative illustrative embodiment of the present invention; and

FIG. 8 is a schematic representation of an example of a server that can be used with the online cooperative story building system of FIG. 1.

### DEFINITIONS

Thread: a story in process of creation composed of a series of thread material.

Thread Material: text, picture, drawing, video, music or any combination thereof.

Thread Seed Material: New thread material posted by the system or a thread editor to start a new thread.

Thread Contributor: a registered member that can contribute to a given thread.

Thread Editor: a registered user which has been given the permission by the system to create, edit and manage a thread. The created thread may be a member public thread or a member private thread. The thread editor may be selected by the system or pay a fee in order to have editing permission.

System Public Thread: a thread created and controlled by the system. Every registered member is a thread contributor for a system public thread.

Member Public Thread: a thread created and controlled by a thread editor. Every registered member is a thread contributor for a member public thread.

Member Private Thread: a thread created and controlled by a thread editor. Only registered members invited by the creating thread editor are thread contributors for a member private thread.

Battling Thread: a hybrid system public thread/member private thread in which thread material is provided by a plurality of member private threads.

### DETAILED DESCRIPTION

Generally stated, the non-limitative illustrative embodiment of the present invention provides an online cooperative story building method and system in which members (users) cooperate in iteratively building story lines in the form of thread by submitting text, pictures, drawings, videos, music or any combination thereof, and voting for their preferred submissions.

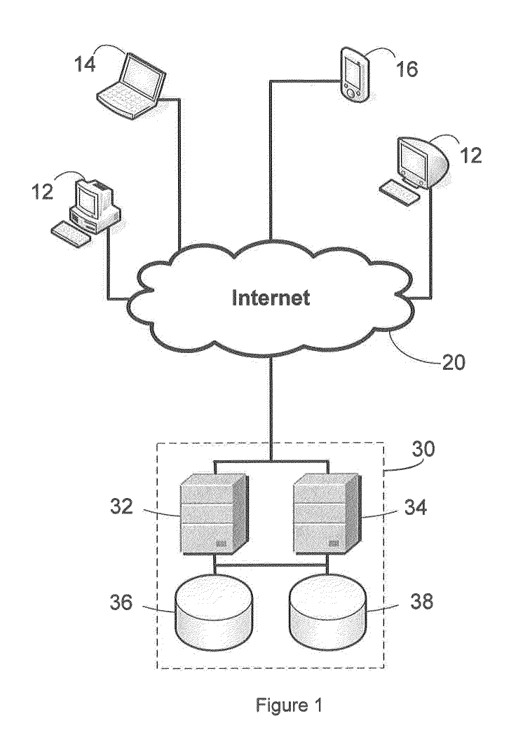

Referring to FIG. 1, a user using a personal computer 12, laptop computer 14, personal assistant device 16, or any other such computing device, on which runs a user interface in the form of a communication software such as, for example, a web browser, may access the online cooperative story budding system 30 through a web portal on a web server 32 via an Internet connection 20 such as, for example, Ethernet (broadband, high-speed), wireless WiFi, cable Internet, satellite connection, cellular or satellite network, etc.

Further to the web server 32, the online cooperative story building system 30 includes a media server 34, a user database 36 and a media database 38, all of which will be detailed further below.

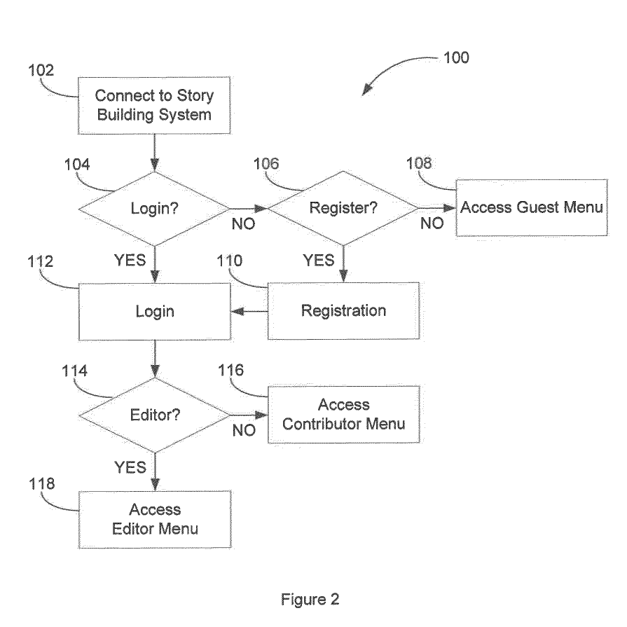

Referring now to FIG. 2, there is shown a flow diagram of the process 100 of accessing the online cooperative story building system 30. Steps of the process 100 are indicated by blocks 102 to 118.

The process 100 starts at block 102 where a user connects to the online cooperative story building system 30 through a web portal on the web server 32.

At block 104, the process 100 verifies if the user wishes to login into the online cooperative story building system 30. If so, the process 100 proceeds to block 112, if not, it proceeds to block 106.

Then, at block 106, process 100 verifies if the user wishes to register with the online cooperative story building system 30. If so, the process 100 proceeds to block 110, if not, it proceeds to block 108 where the user is given access to the guest menu.

At block 110, the user registers and becomes a registered member by entering personal information such as name, email, member identification (e.g. nickname), password, etc, as well as, optionally, payment information such as credit card number, Paypal™ account, etc., which information is saved in the user database 36. The registering member may also select various functionalities which may be provided in exchange for a fee, for example in order to be a thread editor, it is to be understood that various verifications may be executed by the system in order to validate the information provided by the registering user. The process 100 then proceeds to block 112.

At block 112, the user logs into the online cooperative story building system 30 with its member identification and password, which are validated using the user database 36.

Then, at block 114, the process 100 verifies if the member is a thread editor. If so, it proceeds to block 116 were the member is given access to the editor menu, otherwise it proceeds to block 118 where the member is given access to the contributor menu.

### Guest Menu

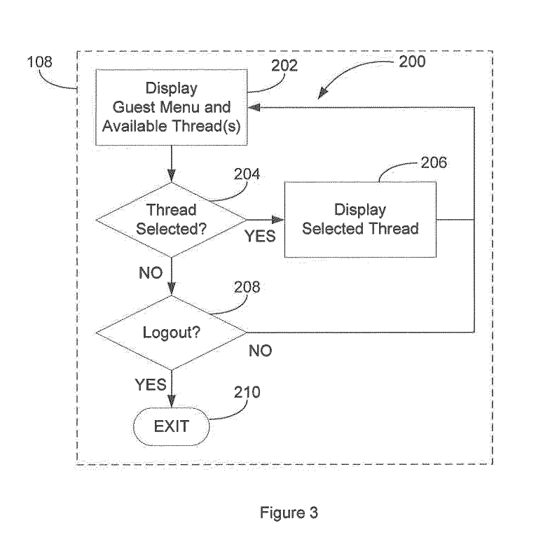

Referring now to FIG. 3, there is shown a flow diagram of the sub-process 200 of a user accessing the guest menu of the online cooperative story building system 30 at block 108 of process 100 of FIG. 2. Steps of the sub-process 200 are indicated by blocks 202 to 210.

The sub-process 200 starts at block 202 where the guess menu is displayed, listing the functions and threads available to guest users, e.g. viewing public system threads or public member threads.

At block 204, the sub-process 200 verifies if the guest user has selected a thread to be displayed and then, if a thread has been selected, displays the selected thread at block 206. The sub-process 200 then proceeds back to block 202.

At block 208, the sub-process 200 verifies if the guest user has selected to logout and then, if the guest user has selected to logout, exits the online cooperative story building system 30 at block 210, if not, the sub-process 200 proceeds back to block 202.

### Contributor Menu

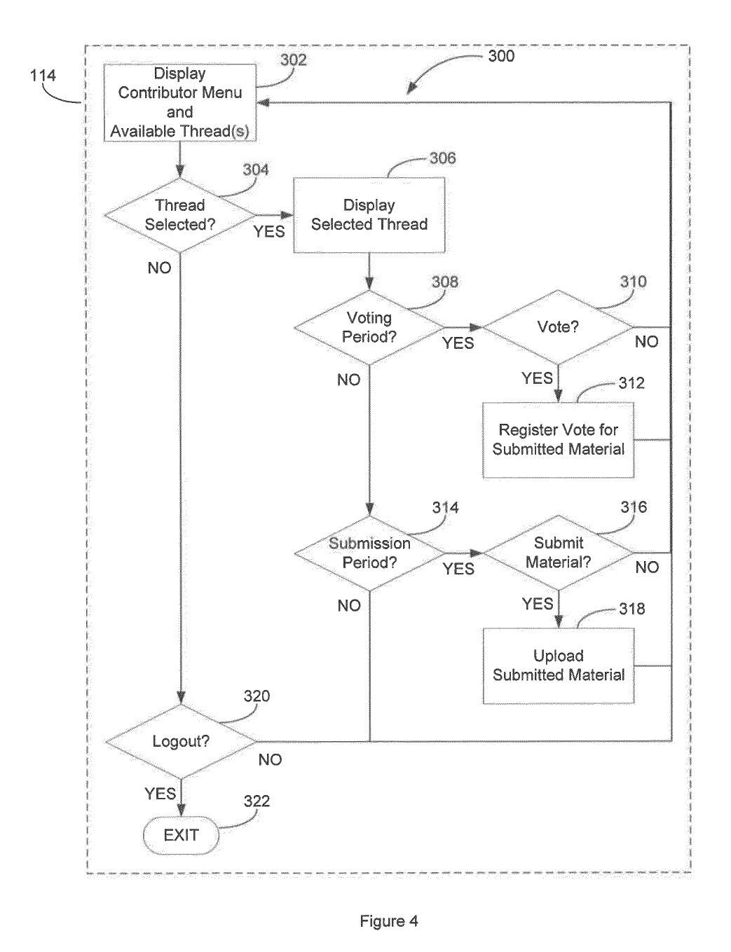

Referring now to FIG. 4, there is shown a flow diagram of the sub-process 300 of a member accessing the contributor menu of the online cooperative story building system 30 at block 114 of process 100 of FIG. 2. Steps of the sub-process 300 are indicated by blocks 302 to 322.

The sub-process 300 starts at block 302 where the contributor menu is displayed, listing the functions and threads available to the contributor, e.g. public system threads, public member threads or private member threads the contributor has been added to.

At block 304, the sub process 300 verifies if the contributor has selected a thread to contribute to and then, if a thread has been selected, displays the selected thread at block 306.

Then, at block 308, the sub-process 300 verifies if the thread is in its voting period. If the thread is in its voting period, the sub-process 300 verifies, at block 310, if the contributor desires to vote for a submitted thread material and, if so, register's the contributor's vote at block 312. The sub-process 300 then proceeds back to block 302.

At block 314, the sub-process 300 verifies if the thread is in its submission period, if the thread is in its submission period, the sub-process 300 verifies, at block 316, if the contributor desires to submit a thread material to the thread and, if so, uploads the submitted thread material to the media database 38 at block 318. It is to be understood that that the size and format of the submitted thread material may be subject to administrator and/or editor maximum size setting and selection of supported formats. In an alternative embodiment, the sub-process 300 may use one or more converters to convert unsupported formats to supported ones. The sub-process 300 then proceeds back to block 302.

At block 320, the sub-process 300 verifies if the contributor has selected to logout and then, if the contributor has selected to logout, exits the online cooperative story building system 30 at block 322. If not, the sub-process 300 proceeds back to block 302.

### Editor Menu

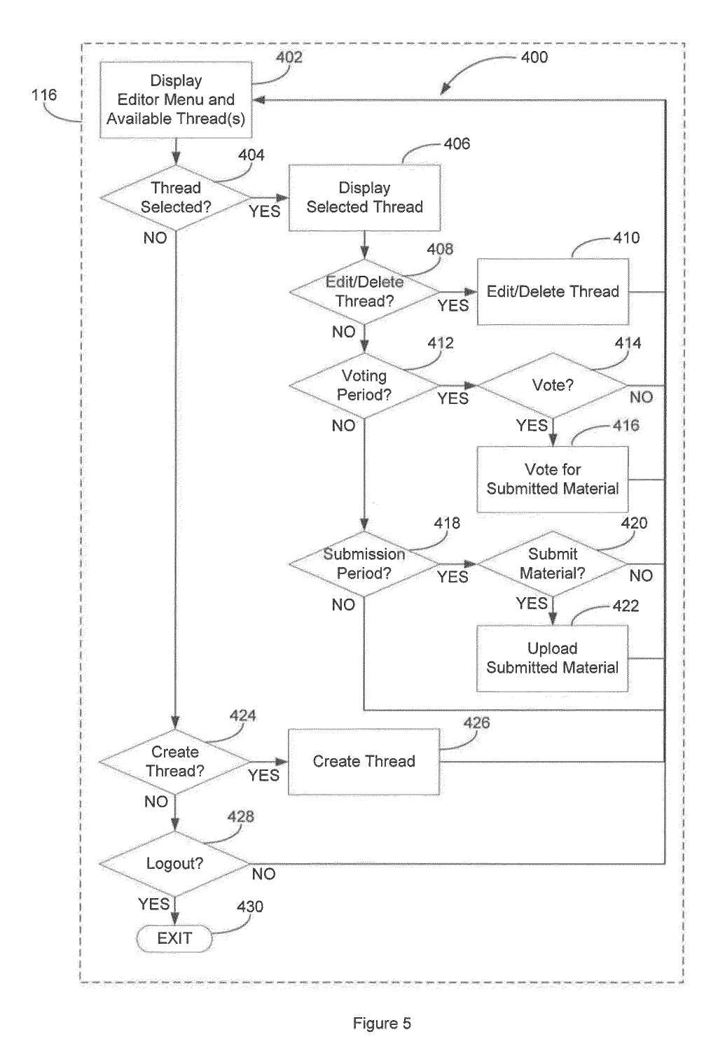

Referring now to FIG. 5, there is shown a flow diagram of the sub-process 400 of a member accessing the editor menu of the online cooperative story building system 30 at block 116 of process 100 of FIG. 2. Steps of the sub-process 400 are indicated by blocks 402 to 430.

The sub-process 400 starts at block 402 where the editor menu is displayed, listing the functions and threads available to the editor, e.g. public system threads, public member threads or private member threads the contributor has either been added to or is the creator.

At block 404, the sub-process 400 verifies if the editor has selected a thread to contribute to or edit and then, if a thread has been selected, displays the selected thread at block 406.

Then, at block 408, the sub-process 400 verifies if the editor has selected to edit or delete the selected thread and if so, at block 410, either deletes the selected thread from the media database 38 or provides editing tools to the editor, e.g. to modify text, remove submitted material, select submitted material for voting, add or remove contributors and/or editors (optionally, the system may not alloy the removal of the editor that created the thread), add or change the maximum number of submitted thread materials, set or change the maximum size of submitted thread materials, set the thread as a public or private member thread, close the thread, etc., and updates the media database 38. The sub-process 400 then proceeds back to block 402.

At block 412, the sub-process 400 verifies if the thread is in its voting period. If the thread is in its voting period, the sub-process 400 verifies, at block 414, if the editor desires to vote for a submitted thread material and, if so, register's the editor's vote at block 416. The sub-process 400 then proceeds back to block 402.

At block 418, the sub-process 400 verifies if the thread is in its submission period. If the thread is in its submission period, the sub-process 400 verifies, at block 420, if the editor desires to submit a thread material to the thread and, if so, uploads the submitted thread material to the media database 38 at block 422. It is to be understood that that the size and format of the submitted thread material may be subject to administrator and/or editor maximum size setting and selection of supported formats. In an alternative embodiment, the sub-process 400 may use one or more converters to convert unsupported formats to supported ones. The sub-process 400 then proceeds back to block 402.

At block 424, the sub-process 400 verifies if the editor has selected to create a new thread and if so, at block 426, creates a new entry in the media database 38 and provides editing took to the editor, e.g. to add text, add a thread seed material, add contributors and/or editors, set a maximum number of submitted thread materials, set the maximum size of submitted thread materials, set the thread as a public or private member thread and, optionally, set the voting and/or submission periods, set the supported submitted thread material formats, etc. The sub-process 400 then proceeds back to block 402.

At block 428, the sub-process 400 verifies if the editor has selected to logout and then, if the editor has selected to logout, exits the online cooperative story building system 30 at block 430. If not, the sub-process 400 proceeds back to block 402.

It is to be understood that other functionalities may be added to the various menus such as, for example, chat and Email services.

### Thread Update

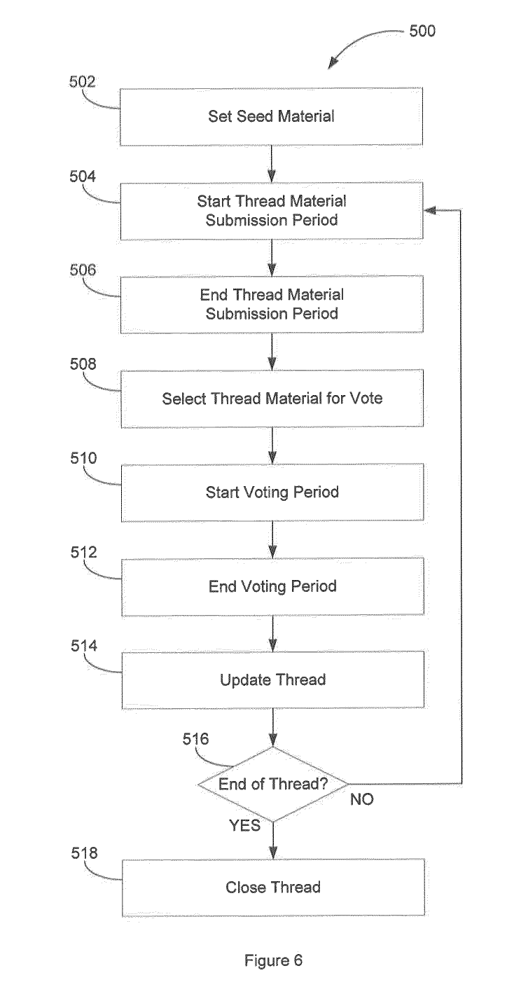

Referring now to FIG. 6, there is shown a flow diagram of the thread update process 500 which may be completely executed by the online cooperative story building system 30, completely executed by an editor or a combination of execution by the online cooperative story building system 30 and an editor. Steps of the process 500 are indicated by blocks 502 to 518.

The process 500 starts at block 502 where a thread seed material is set for the newly created thread.

At block 504, the thread material submission period is started during which contributors of the thread may submit new thread materials.

Then, at block 506, the thread material submission period is ended, having for consequence that no further thread materials may be submitted to the thread.

At block 508, some or all of the submitted thread materials are selected for voting.

At block 510, the thread material voting period is started during which contributors of the thread may vote for their preferred thread material selected for voting.

Then, at block 512, the thread material voting period is ended, having for consequence that no further votes may be registered.

Following this, at block 514, the thread is updated with the thread material having had the most votes and the other thread materials are removed. It is to be understood that the thread materials that are removed may be kept in the media database 38 and may be brought back by an editor in the case where a selected thread material has to be removed because of, for example, irregular voting or copyright issues, or any other reason.

Finally, at block 516, if the thread has reached its end, the process 500 proceeds to block 518 where the thread is closed (i.e. no more thread materials may be submitted but the thread may still be viewed/displayed). If the thread has not reached its end, the process 500 proceeds back to block 504 where a new thread material submission period is started.

It is to be understood that a thread may close at a predetermined time by the system or may be closed at any time by an editor. It is also to be understood that a closed thread may be reopened.

### Battling Thread Update

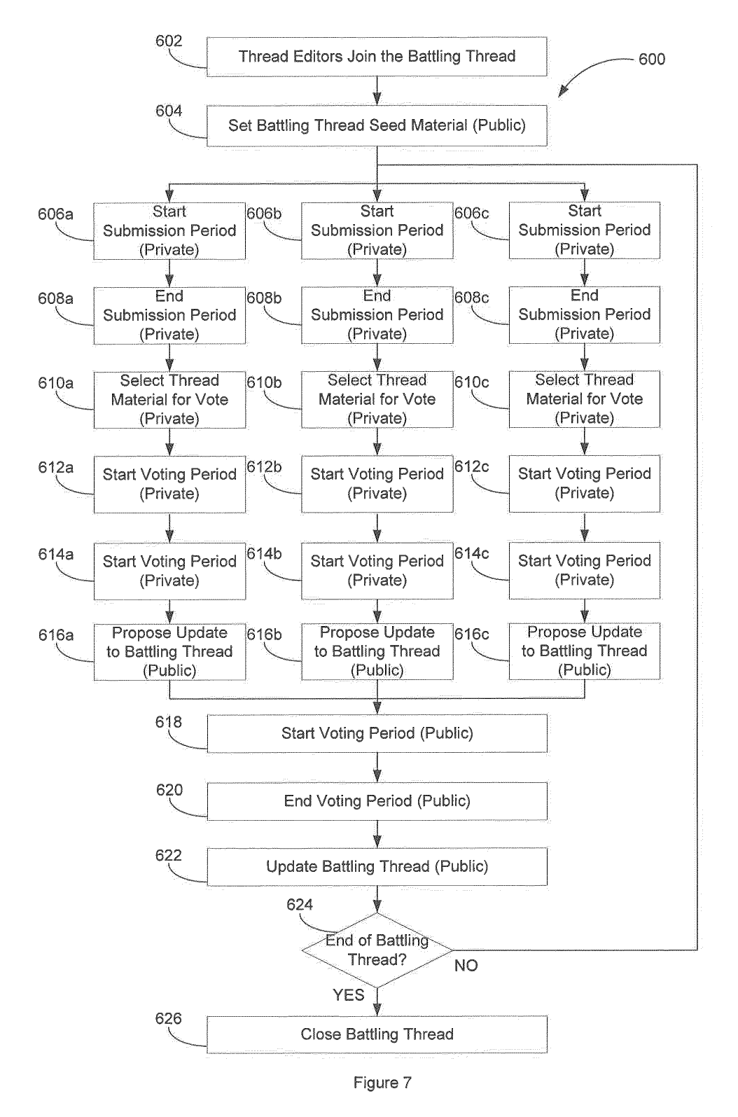

Referring now to FIG. 7, there is shown a flow diagram of the battling thread update process 600. The battling thread is a hybrid thread in that part of it is considered a system public thread (i.e. blocks 604 and 616 to 622) while another is considered a member private thread (i.e. blocks 606 to 614). Steps of the process 600 are indicated by blocks 602 to 628.

The process 600 starts at block 602 where thread editors are invited, for example by an administrator of the system, to on the battling thread.

At block 604, a battling thread seed material is set for the battling thread. The bathing thread seed material is viewable by the public.

Then, blocks 606a, b and c to 616a, b and c are executed privately for each invited thread editor, i.e. blocks 606a to 616a for a first invited editor; blocks 606b to 616b for a second invited editor; blocks 606c to 616c for a third invited editor, etc.), essentially creating parallel temporary private member threads. This means that only contributors belonging to each temporary parallel private member thread may contribute to that thread in blocks 606 to 616.

At blocks 606a, b and c the thread material submission period is started for each temporary private thread (i.e. a, b or c) during which contributors of the thread may submit new thread materials.

Then, at block 608a, b and c the thread material submission period is ended for each temporary private thread, having for consequence that no further thread materials may be submitted to the thread.

At block 610a, b and c, some or all of the submitted thread materials for each temporary private thread are selected for voting.

At block 612a, b and c, the thread material voting period is started for each temporary private thread during which contributors of the thread may vote for their preferred thread material selected for voting.

Then, at block 614a, b and c, the thread material voting period is ended for each temporary private thread, having for consequence that no further votes may be registered.

Following this, at block 616a, b and c, each temporary private thread proposes the thread material having had the most votes as a thread update to the bathing thread and the other thread materials are removed. It is to be understood that the thread materials that are removed may be kept in the media database 38 and may be brought back by an editor in the case where a selected thread material has to be removed because of, for example, irregular voting or copyright issues.

At block 618 the battling thread material voting period is started during which contributors of the bathing thread (i.e. registered members) may vote for their preferred thread material update proposal from each of the temporary private threads.

Then, at block 620, the battling thread material voting period is ended, having for consequence that no further votes may be registered.

Following this, at block 622, the battling thread is updated with the thread material update proposal having had the most votes and the other thread material update proposals are removed. It is to be understood that the thread material update proposals that are removed may be kept in the media database 38 and may be brought back by the system in the case where a selected thread material update proposal has to be removed because of, for example, irregular voting or copyright issues.

Finally, at block 624, if the battling thread has reached its end, the process 600 proceeds to block 826 where the battling thread is closed (i.e. no more thread material may be submitted but the battling thread may still be viewed/displayed), if the battling thread has not reached its end, the process 600 proceeds back to block 606a, b and c, where a new thread material submission period is started for each temporary private thread.

Although the above description refers to three invited editors, it is to be understood that that two or even more than three editors may be invited, in which case blocks 606 to 616 will be repeated for each invited editor.

The battling thread described above may be used, for example, in the context of a competition between schools, contests, promotional events, etc.

It is to be understood that although throughout the disclosure reference is made to separate servers 32 and 34 as well as separate databases 36 and 38, these may be implemented on one or more physical device and/or may be combined. It is to be further understood that the user 36 and media 38 databases may equally be implemented by a data structure within a computer memory.

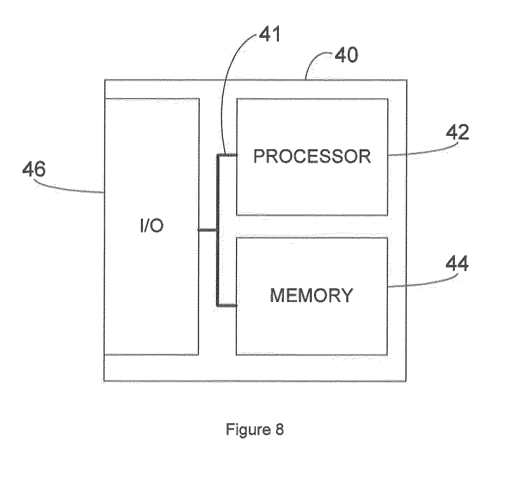

Referring to FIG. 8, there is shown an example of a physical device 40 that may be used to implement the servers 32 and 34, and/or databases 36 and 38. The physical device 40, for example a computer, generally comprises a processor 42, a memory 44 and an Input/Output interface 46 operatively interconnected via a databus 41. The processor 42 executes the steps of processes 100, 500 and 600 (see FIGS. 1, 6 and 7) as well as sub-processes 200, 300 and 400 (see FIGS. 3, 4 and 5), which may be stored as computer executable code in the memory 44 so as to be executed by the processor 42. Furthermore, the user 36 and/or media 38 databases may be implemented by a data structure stored in the memory 44. The Input/Output interface 46 allows communication with the Internet connection 20 as well as with other servers and databases.

Although the present invention has been described by way of particular embodiments and examples thereof, it should be noted that it will be apparent to persons skilled in the art that modifications may be applied to the present particular embodiment without departing from the scope of the present invention.

What is claimed is:

1. A computer implemented method for allowing users to cooperate in iteratively building a story, the method comprising:
a. setting a seed material for the story;
b. starting a material submission period;
c. prompting the users to submit materials;
d. uploading the submitted materials;
e. ending the material submission period;
f. starting a voting period for the submitted materials;
g. registering votes from the users for each of the submitted materials;
h. ending the voting period;
i. identifying one of the submitted materials having the highest number of registered votes; and
j. updating the story with the identified submitted material.

2. A method according to claim 1, wherein steps b to j are repeated for a predetermined number of times.

3. A method according to claim 1, further comprising the step of:
ff. selecting two or more of the submitted materials;
and wherein step g consist in registering votes from the users for each of the selected submitted materials

4. A method according to claim 1, wherein the seed material and the submitted materials are selected from the group consisting of text, pictures, drawings, video and music.

5. A method according to claim 1, further comprising the step of:
aa. registering the users;
and wherein steps c and g are only performed for registered users.

6. A method according to claim 1, wherein steps b to i are performed for a plurality of groups of users and step i identifies one of the submitted materials for each of the groups of users and further comprising the steps of;
i1. starting a second voting period;
i2. registering votes from the users for each of the submitted materials identified at step i;
i3. ending the voting period; and
i4. identifying one of the submitted materials identified at step i having the highest number of registered votes.

7. A system for allowing users to cooperate in iteratively building a story, the system comprising:
a media database;
an input;
an output;
a processor operatively connected to the database, the input and the output, wherein the processor is so configured so as to;
a. set a seed material for the story;
b. start a material submission period;
c. prompt the users to submit materials through the output;
d. upload the submitted materials to the media database through the input;
e. end the material submission period;
f. start a voting period for the submitted materials through the output;
g. register votes from the users for each of the submitted materials through the input;
h. end the voting period;
i. identify one of the submitted materials in the media database having the highest number of registered votes; and
j. update the story with the identified submitted material.

8. A system according to claim 7, wherein the processor executes steps b to j a predetermined number of times.

9. A system according to claim 7, wherein the processor is further configured so as to:
ff. select two or more of the submitted materials;
and wherein step g consist in registering votes from the users for each of the selected submitted materials

10. A system according to claim 7, wherein the seed material and the submitted materials are selected from the group consisting of text, pictures, drawings, video and music.

11. A system according to claim 7, further comprising:
a user database;
and wherein the processor is further configured so as to:
aa. register the users in the user database;
and wherein steps c and g are only executed by the processor for users registered in the user database.

12. A system according to claim 7, wherein the processor executes steps b to i for a plurality of groups of users and step i identifies one of the submitted materials for each of the groups of users, the processor being further configured so as to:
i1. start a second voting period;
i2. register votes from the users for each of the submitted materials identified at step i;
i3. end the voting period; and
i4. identify one of the submitted materials identified at step i having the highest number of registered votes.
